(19) United States
(12) Patent Application Publication
(10) Pub. No.: US 2017/0287089 A1
(43) Pub. Date: Oct. 5, 2017

(54) CONTENT INFORMATION DISPLAY SYSTEM WITH REPRINT PERMISSION AND CONTENT INFORMATION DISPLAY METHOD WITH REPRINT PERMISSION

(71) Applicant: Hitoshi ISHIDA, Tokyo (JP)

(72) Inventor: Hitoshi ISHIDA, Tokyo (JP)

(21) Appl. No.: 15/430,565

(22) Filed: Feb. 13, 2017

(30) Foreign Application Priority Data
Feb. 18, 2016 (JP) 2016-029367

(51) Int. Cl. G06Q 50/18

(52) U.S. Cl. CPC G06Q 50/18

(57) ABSTRACT

Review information, etc. are important marketing information for users and companies.

A large majority of review information, etc. are displayed on limited websites, and are not widely released for users' use. As review information, etc. have copyrights at the time of being written as original information, license or permission of each author is primarily required, in order to be widely available to users.

A content author generates reprint permission information indicating reprint permission of content information in a state where a third party can acquire the content information on a network, and writes, as content information with reprint permission, the reprint permission information along with the content information. A person who wants to reprint can reprint review information, etc. based on reprint permission information in the content information with reprint permission.

### CROSS-REFERENCE TO RELATED APPLICATIONS

This application is a continuation of U.S. application Ser. No. 15/430,565, filed Feb. 13, 2017, which claims priority from a Japanese patent application No. 2016-029367, filed on Feb. 18, 2016, the entire content of which is incorporated herein by reference.

### BACKGROUND OF THE INVENTION

The present invention relates to a system and a method for displaying, with respect to content information which is displayed on a network, reprint permission or reprint license by an author of said content information, to enable reprint and reuse of the content information by a third party.

Mouth-to-mouth information, evaluation, review information and the like (hereinafter referred to as “review information, etc.”) on networks, which are pertaining to products and services, serve as valuable marketing information for companies providing those products and services.

At the same time, review information, etc. serve as important reference data for users, customers and consumers (hereinafter referred to as “customers, etc.”) who newly purchase or use said products and services in the future.

Here, a network in the abovementioned networks is configured so as to be netlike and to keep in contact, such like the Internet and www (World Wide Web) that are computer networks in which individual communications are mainly performed, and broadcast networks (broadcasting) that mainly perform simultaneous broadcasting.

### DESCRIPTION OF THE RELATED ART

Japan patent application NO. 2010-226225.

Abstract of the patent application NO. 2010-226225 is following:

Analyze mouth-to-mouth information on the communication network to make it easy to grasp the tendency of satisfaction points and dissatisfaction points about services or products. The mouth-to-mouth information management system 11 accesses the registration web site, collects the information of the mouth-to-mouth posted on the registered website and stores them in the mouth-to-mouth information storage unit 27, analyzes the mouth-to-mouth information in the mouth-to-mouth information storage unit 27 by analyzer 29.

With respect to review information, etc., some technologies on collecting method and analyzing method therefore have been introduced to date, and there are cases where analysis businesses and the like are already deployed to companies.

Meanwhile, review information, etc. have copyrights at the time of being written as original information, and when a third party reuses the review information, etc., the third party is primarily required to be licensed or permitted by the author with respect to the duplication, public transmission, distribution, translation, adaptation, edition, and rights on Copyright Act of the review information, etc.

If many companies and customers, etc. can widely reuse review information, etc., it would be very useful in developing better products and services, cultivating smart customers, etc., and improving customer convenience.

However, it is realistically difficult in the present circumstances to acquire permission of authors of review information, etc. one by one, thereby clearing the relationship of rights; therefore, it is in a situation where it is not possible to widely reuse review information, etc.

And, there is not negligible the number of authors, among authors of review information, etc., who want to expose their review information, etc. that they wrote in specific websites, widely to society, thereby to be useful for companies and customers, etc. When widely exposing review information, etc., the author thereof naturally wishes that his/her will is respected with regard to the duplication, public transmission, distribution, translation, adaptation, edition, and rights on Copyright Act of his/her review information, etc. However, a method for conveniently granting said wish is not provided in the present circumstances.

There are businesses, among service businesses for collecting and analyzing review information, etc., which already started services, in which permissions of authors are not obtained; therefore, quick development and provision of a method and a system for solving the situation are required.

### SUMMARY OF THE INVENTION

It is necessary for a third party who wants to reuse review information, etc. to obtain permission or license from the author of the review information, etc. with respect to reuse of the review information, etc.

However, complicated processes and works are required in order to individually obtain permissions and licenses for reusing review information, etc. after said review information, etc. were written in a network or in each website.

Accordingly, provision of a method or system, with which an author of review information, etc. can show what kind of permission will be given with respect to the written work when writing the review information, etc. in a network or in a website, is effective for solving the problem in the current situation.

In addition, said method or system should be configured in such a manner that a person who reuses review information, etc. described in a network can clearly and quickly determine whether or not the review information, etc., among a large amount of review information, etc. described in a network, obtained reuse permission of the author thereof.

Furthermore, it is important to provide an incentive for permission work to an author of review information, etc., in order to have the author aggressively perform the permission work which indicates permission for reusing the review information, etc., said permission work having been unnecessary in previous work for writing in.

The present invention provides a method and a system for solving the problems above, and easily enabling reuse of review information, etc., which companies, customers, etc. and authors of review information, etc. desire.

The content reprint permission display system according to the first invention of the present application is provided with a reprint permission information display unit which generates or displays reprint permission information indicating reprint permission of content information in a state where a third party can acquire the reprint permission information on a network, and a unit for displaying content information with reprint permission, which generates or displays, as content information with reprint permission, the content information along with the reprint permission information generated or displayed by the reprint permission information display unit.

The content reprint permission display system according to the second invention of the present application is provided with a reprint permission information display unit which generates or displays reprint permission information indicating reprint permission of content information in a state where a third party can acquire the reprint permission on a network, a unit for displaying content information with reprint permission, which generates or displays, as content information with reprint permission, the content information along with the reprint permission information, and a unit for posting content information with reprint permission, which displays, on a network, content information with the reprint permission generated or displayed by the unit for displaying content information with reprint permission.

The content reprint permission display system according to the third invention of the present application is provided with: a reprint permission information display unit which generates or displays reprint permission information indicating reprint permission of content information, in a state where a third party can acquire the reprint permission on a network; a unit for displaying content information with reprint permission, which generates or displays, as content information with reprint permission, the content information along with the reprint permission information; a unit for posting content information with reprint permission, which displays, on a network, the content information with reprint permission generated or displayed by the unit for displaying content information with reprint permission; a unit for acquiring content information with reprint permission, which collects and acquires content information with reprint permission displayed, on a network, by the unit for posting content information with reprint permission, using the reprint permission information; a unit for storing content information with reprint permission, which stores the collected and acquired content information with reprint permission; and a unit for reprinting content information with reprint permission, which reprints and displays, on a network, the content information with reprint permission stored in the unit for storing content information with reprint permission.

The unit for displaying content information with reprint permission according to the present invention may be further provided with a unit for evaluating content information with reprint permission, in which the content information with reprint permission reprinted by the unit for reprinting content information with reprint permission is evaluated by users who view the content information with reprint permission, and an author rewarding unit which determines to reward the author of the content information with print permission, based on an evaluation value given by evaluation by the unit for evaluating content information with reprint permission.

Reprint permission information in the content reprint permission display system according to the present invention may further include, in addition to said reprint permission information, author's will that is pertinent to at least any one of the duplication, public transmission, distribution, translation, adaptation, edition, and rights on Copyright Act of the content information.

The content reprint permission display system according to the present invention may be further provided with a product/service information acquisition unit that collects and acquires information related to product information and service information which are described in content information the content information with reprint permission, and a product/service information posting unit that displays, on a network, the information related to product information and service information, which is collected and acquired by the product/service information acquisition unit, along with the content information.

The present invention posts or displays reprint permission information indicating reprint permission and the like in content information posted or displayed on a network, in a state where a third party can acquire the reprint permission information on the network, thereby facilitating acquisition of permission and license for reprint and reuse of the content information, which has been difficult.

Therefore, said feature enables effectively reposting and reusing of content information, and is useful for product/service providing companies to improve their businesses, useful for customers, etc. as reference at the time of purchasing or using the product/service, and useful for the author of the content information in dispersing the information and acquiring the evaluation thereof.

### BRIEF DESCRIPTION OF THE DRAWINGS

FIG. 1 is an example of a functional block diagram illustrating the overall configuration of a content reprint permission display system according to the present invention.

FIG. 2 is an example of a content configuration diagram of content reprint permission information that is displayed by the content reprint permission information display unit illustrated in FIG. 1.

FIG. 3 is an example of a flowchart showing a processing procedure pertaining to generation or display of content information with reprint permission, by the content reprint permission display system illustrated in FIG. 1.

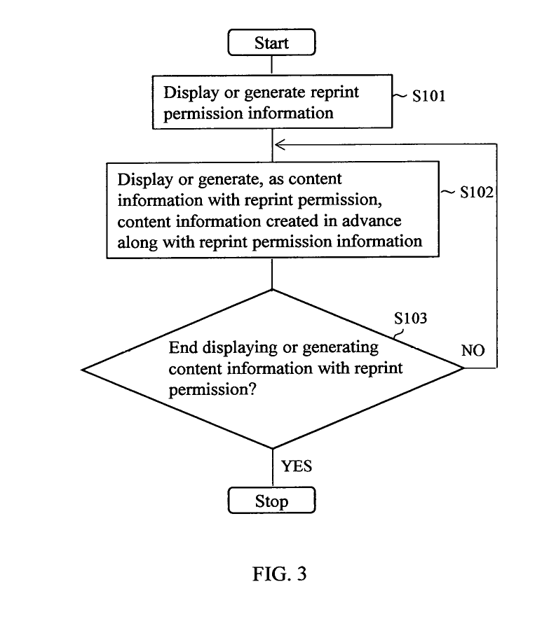

FIG. 4 is an example of a flowchart showing a processing procedure pertaining to posting of content information with reprint permission, by the content reprint permission display system illustrated in FIG. 1.

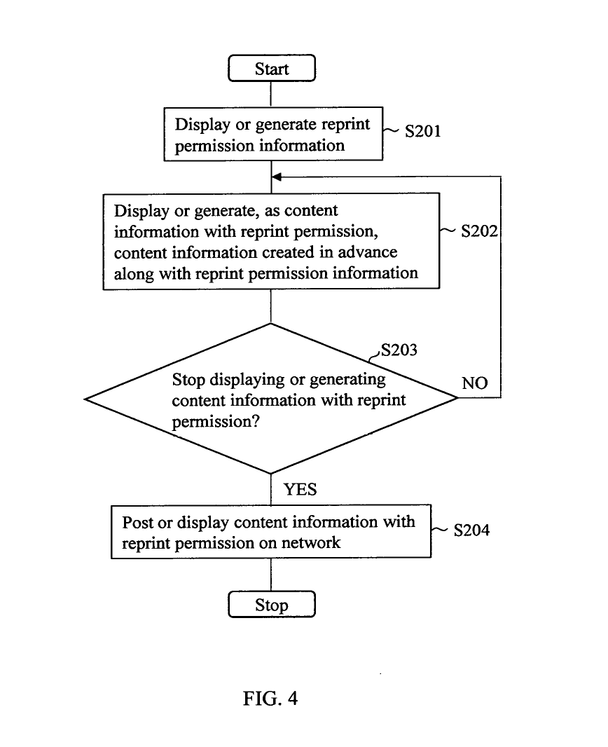

FIG. 5 is an example of a flowchart showing a processing procedure pertaining to search, collection and acquisition of content information with reprint permission present on a network, and reprint of the acquired content information with reprint permission into the network, by the content reprint permission display system illustrated in FIG. 1.

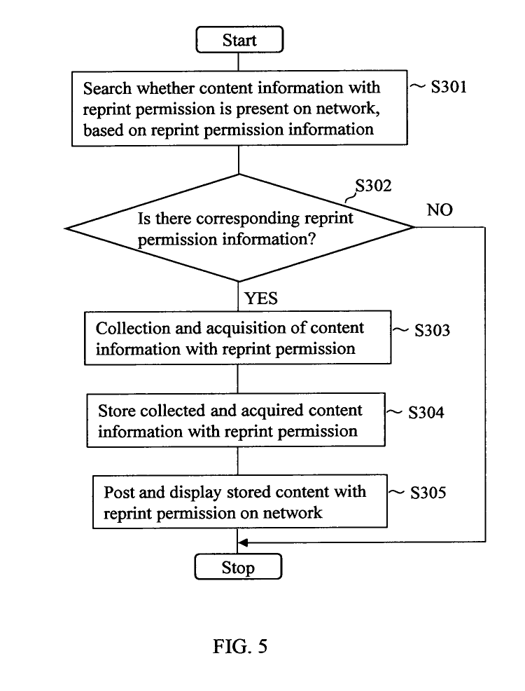

FIG. 6 is an example of a flowchart showing a processing procedure pertaining to evaluation by users of content information with reprint permission posted on a network, and provision of reward based on the evaluation, by the content reprint permission display system illustrated in FIG. 1.

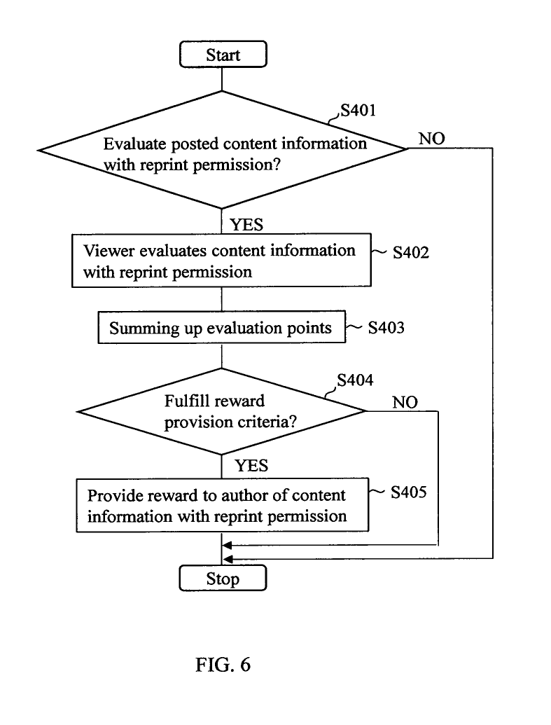

### DESCRIPTION OF THE EMBODIMENTS

An embodiment of a content reprint permission display system according to the present invention is explained below referring to drawings.

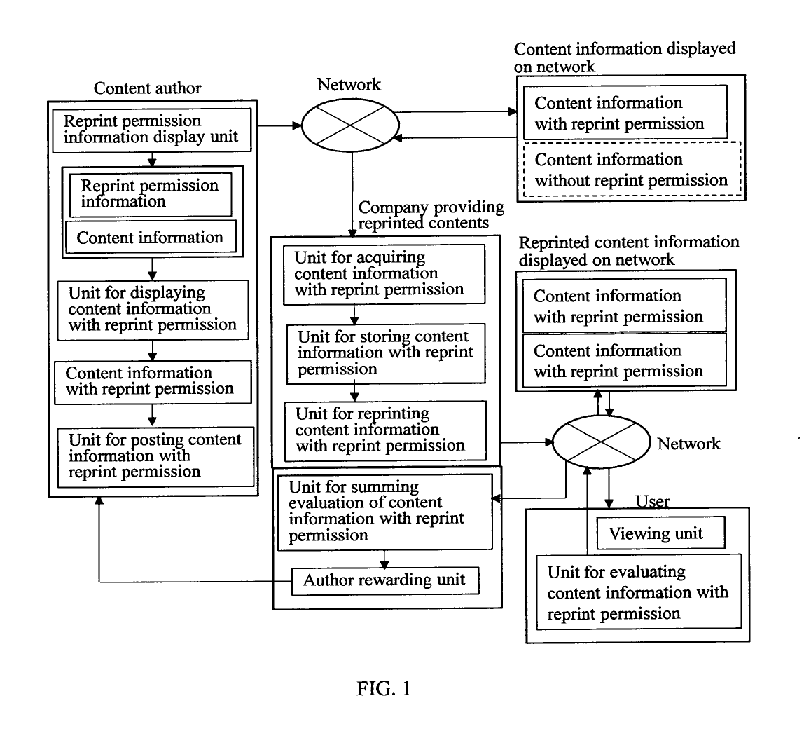

First, the overall configuration of a content reprint permission display system according to the present invention is explained referring to FIG. 1.

A content author (content information production rights holder or content information producer) generates or creates reprint permission information using a reprint permission information display unit, in order to permit (license) reprint, by a third party, of content information which was created in advance.

The reprint permission information display unit generates reprint permission information in a state where a third party can acquire said reprint permission information on a network.

The reprint permission information display unit may generate reprint permission information as a hash value, may generate same using a public encryption key, or may generate same simply as text data, image data or voice data which can be published.

The reprint permission information is configured in such a manner that the content author, after having generated or created the reprint permission information, adds the reprint permission information to content information which was created in advance, thereby permitting reprint of said content information by a third party.

In addition, reprint permission information created by a third party may be added to content information which a content author produced by acquisition, or acquisition and edition, or duplication, depending on the situation.

The reprint permission information display unit generates or creates reprint permission information in a state where a third party can acquire said reprint permission information on a network. The state where a third party can acquire reprint permission information on a network means a state where the third party can search, for example, on a network to which the third party connects via the network. Published text information, published ID (content ID, manager ID, file format ID, service name ID and the like; note that published ID is not limited to those listed here, as far as the published ID can be searched on a network by a third party), published key, published waveform (voice waveform and the like, for example), frequency and the like are used for achieving a searchable state on a network.

The reprint permission information may further include display of, in addition to said reprint permission information, the will of copyright holder pertaining to at least either one of duplication, public transmission, distribution, translation, adaptation, edition, and rights on Copyright Act of the content information.

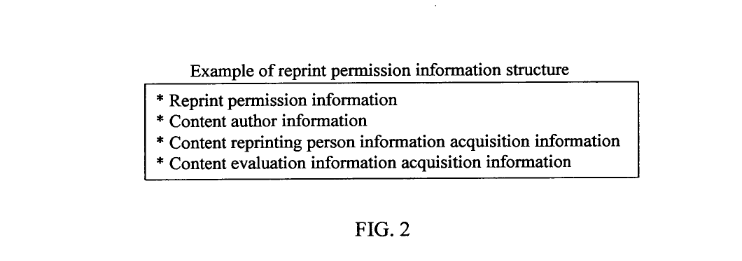

In addition, the reprint permission information may include, in addition to said reprint permission information, at least either one of content author information, content reprinting person information acquisition information and content evaluation information acquisition information. (See FIG. 2)

Here, the content author information means information on the author of a content, which are the identification information (email address, some IDs, instantly granted number, symbol and the like, and others, for example), name, nickname, various kinds of contact information (mailing address, telephone number and the like, for example) and information (address, financial institution information, various kinds of point manager information, and the like), for example, of the author. Note that the content of the content author information is not limited to the contents listed here, but may be any content as far as said content can provide the service of the present invention.

In addition, the content reprinting person information acquisition information means information for acquiring information on a third party who reprints content information of a content author. In other words, said information acquires information on who the third party is, and the place where, the time when and the purpose for which the third party reprints the content information of the content author.

The abovementioned “information for acquiring information” means, for example, information for acquiring, via a network, information (electronic information and the like which can be identification information) on a third party who wants to reprint, by displaying that the content author acquires content reprinting person information, and by causing the third party to fill out the information on said third party or reading out said information, when said third party who wants to reprint content acquires, via a network, content information with reprint permission generated by the content author, or when said third party reprints said content information to other place, Information to be automatically read out and transmitted as information on a person who wants to reprint content includes, for example, IP address of the person who wants to reprint, user information on SNS which the person who wants to reprint content uses, information on place (URL) on a network where the person who wants to reprint content reprinted the content information with reprint permission, and the time at which the content information with reprint permission was reprinted. Note that the content reprinting person information acquisition information may not acquire all said information.

The content reprinting person information acquisition information may be created or configured using a program such as JavaScript (registered trademark), PHP and Ruby. Information to be automatically transmitted as information on a person who wants to reprint content includes, for example, IP address of the person who wants to reprint content, user information on SNS that the person who wants to reprint content uses, information on place (URL) on a network where the person who wants to reprint content reprinted the content information with reprint permission, and the time at which the content information with reprint permission was reprinted.

Note that the content of the content reprinting person information acquisition information and the method therefore are not limited to the content and method listed here, but may be any content and method as far as said content and method can provide the service of the present invention.

The content evaluation information acquisition information is information for acquiring an evaluation result of content author's content information which was reprinted by a third party, said evaluation being made by content viewers who viewed the reprinted content information.

The content evaluation information acquisition information may be created or configured using a program such as JavaScript (registered trademark), PHP and Ruby. Note that the content of the content evaluation information acquisition information and the method for acquiring same are not limited to the content and method listed here, but may be any content and method as far as said content and method can provide the service of the present invention.

The unit for displaying content information with reprint permission adds, to content information that is created by a content author in advance, reprint permission information that is generated or created by a reprint permission information display unit, thereby generating or creating content information with reprint permission.

The unit for posting content information with reprint permission is for posting, on a network via the network, the content information with reprint permission by a content author thereof.

The content author can post, on a website to which the content author is registered, the content information with reprint permission, or upload and post same, using FTP, on a server that is independently managed, for example, using the unit for positing content information with reprint permission and an information terminal such as personal computer and smartphone, that can send/receive information via a network.

The person who wants to reprint content can search content information with reprint permission from among a tons of contents content information present on a network, using the unit for acquiring content information with reprint permission and reprint permission information in the content information with reprint permission. For example, it is possible to search content information with reprint permission by connecting to a search engine site on World Wide Web using a sending/receiving unit of information communication terminal equipment such as personal computer.

The person who wants to reprint content can use a search website and the like to search content information with reprint permission, and store the collected and acquired (downloaded) content information with reprint permission on a storage device or external storage device in an information equipment terminal such as personal computer of the person who wants to reprint content, or on a storage unit such as storage server, which is connectable via a network.

The person who wants to reprint content can read out content information with reprint permission stored in a storage unit of an information equipment terminal and the like, and connect, via a network, to a place on a network, at which the person who wants to reprint the content, thereby reprinting the content information with reprint permission thereon, using the unit for reprinting content information with reprint permission.

In the case where there is content reprinting person information acquisition information in the content information with reprint permission which the person who wants to reprint content acquired, and a request for reporting information on the person who wants to reprint content is received via a network, the information on the person who wants to reprint content is sent to the content author thereof according to the request. Note that there is a case where, even when content reprinting person information acquisition information is included in the reprint permission information, the request for reporting information on the person who wants to reprint content is not displayed to the person who wants to reprint content. In that case, there is a case where the content reprinting person information acquisition information automatically sends, to the content author via a network, the information on the person who wants to reprint content using the sending/receiving unit of the communication terminal of the person who wants to reprint content.

Information to be automatically sent as the information on a person who wants to reprint content includes, for example, IP address of the person who wants to reprint content, user information on SNS which the person who wants to reprint content uses, information on place (URL) on a network, at which the person who wants to reprint content reprinted the content information with reprint permission, and the time at which the content information with reprint permission was reprinted. Note that, in implementation of the present invention, there is a case where content reprinting person information acquisition information is not included in reprint permission information.

The content information with reprint permission which was reprinted on other place on a network by the person who wants to reprint content is widely viewed by general users. Note that the content information with reprint permission which was reprinted on other place may also be viewed by limited users who are registered as members.

The content information with reprint permission which was reprinted on other place can be evaluated by users who view the content information, using the unit for evaluating content information with reprint permission.

Content information with reprint permission which was evaluated by many users means that the content author thereof is evaluated.

A method for evaluating in the unit for evaluating content information with reprint permission is preferably configured to be a score evaluation in which a score is evaluated by a 5-point scale, for example.

An evaluation value given by the evaluation by users by means of the unit for evaluating content information with reprint permission is configured so as to be reflected, via a network, to the website and the like, on which the content information with reprint permission is reprinted.

In a case where content evaluation information acquisition information is included in reprint permission information in content information with reprint permission which users view, the scores or the sum thereof given by evaluation by the users by means of the unit for evaluating content information with reprint permission, and the number and time of browsing are configured so as to be sent to the content author via a network. Note that all of content evaluation information acquisition information may not necessarily acquire all such information.

A person who wants to reprint content, a third company or organization, or the like sums up evaluation of content information with reprint permission which users evaluated, using a unit for summing up evaluation of content information with reprint permission.

The unit for summing up evaluation of content information with reprint permission sums up evaluation values by the users, and displays the summed evaluation values in descending order.

A person who wants to reprint, a third company or organization, or the like provides, via a network, a report indicating provision of a reward to the content author of content information with reprint permission, using content author information in reprint permission information, based on evaluation values which the unit for summing up evaluation of content information with reprint permission summed up by means of an author rewarding unit.

The reward provided via a network by the author rewarding unit includes, for example, provision of points that can be used on the network. In the abovementioned case of “providing a report indicating provision of a reward”, it is possible to provide at a later date, as the reward, any service, product, cash or financial product, such as various gift certificates, various types of equipment, book and cash, for example.

It is thereby possible to help the content author aggressively create useful content and post the content on a network as content information with reprint permission, which enables, as a result thereof, users and companies to view and obtain better marketing information.

When the author rewarding unit provides a reward to a content author, the reward may be provided to the content author who won an evaluation value exceeding a certain evaluation value which was determined in advance. In that case, a content author can wait for provision of a reward while confirming the sum and the like of the content information evaluation.

What is claimed is:

1. A content reprint permission display system provided with
a reprint permission information display unit which generates or displays reprint permission information indicating reprint permission of content information in a state where a third party can acquire the reprint permission information on a network, and
a unit for displaying content information with reprint permission, which generates or displays, as content information with reprint permission, the content information along with the reprint permission information generated or displayed by the reprint permission information display unit.

2. A content reprint permission display system described in claim 1, wherein the reprint permission information further includes, in addition to said reprint permission information, at least one of content author information, content reprinting person information acquisition information, content evaluation information acquisition information and information pertaining to reception of a reward.

3. A content reprint permission display system described in claim 1, wherein the reprint permission information further includes, in addition to said reprint permission information, the will of copyright holder pertaining to at least either one of duplication, public transmission, distribution, translation, adaptation, edition, and rights on Copyright Act of the content information.

4. A content reprint permission display system provided with
a reprint permission information display unit which generates or displays reprint permission information indicating reprint permission of content information in a state where a third party can acquire the reprint permission information on a network,
a unit for displaying content information with reprint permission, which generates or displays, as content information with reprint permission, the content information along with the reprint permission information, and
a unit for posting content information with reprint permission, which displays, on a network, the content information with reprint permission generated or displayed by the unit for displaying content information with reprint permission.

5. A content reprint permission display system provided with
a reprint permission information display unit which generates or displays reprint permission information indicating reprint permission of content information in a state where a third party can acquire the reprint permission information on a network,
a unit for displaying content information with reprint permission, which generates or displays, as content information with reprint permission, the content information along with the reprint permission information,
a unit for posting content information with reprint permission, which displays on a network the content information with reprint permission generated or displayed by the unit for displaying content information with reprint permission,
a unit for acquiring content information with reprint permission, which collects and acquires the content information with reprint permission displayed on the network by the unit for posting content information with reprint permission, using the reprint permission information,
a unit for storing content information with reprint permission, which stores the collected and acquired content information with reprint permission, and
a unit for posing content information with reprint permission, which reprints and displays on the network the content information with reprint permission stored in the unit for storing content information with reprint permission.

6. A content reprint permission display system describe in claim 5, which is further provided with
a unit for evaluating content information with reprint permission, which evaluates the content information with reprint permission reprinted by the unit for reprinting content information with reprint permission by users who view the content information, and
an author rewarding unit which determines provision of a reward to the author of the content information with reprint permission, based on evaluation values given by the unit for evaluating content information with reprint permission.

7. A content reprint permission display system describe in claim 5, which is further provided with
a product/service information acquisition unit which collects and acquires information related to product information and service information that are described in content information in the content information with reprint permission, and
a product/service information posting unit, which displays on a network the information related to product information and service information that are collected and acquired by the product/service information acquisition unit, along with the content information.
